(19) United States
(12) Patent Application Publication
(10) Pub. No.: US 2025/0277763 A1
(43) Pub. Date: Sep. 4, 2025

(54) DEVICES AND SYSTEMS FOR EXPERIMENTAL FORWARD MODEL INDEXING OF ELECTRON BACKSCATTER DIFFRACTION PATTERNS

(71) Applicant: Gatan Inc., Warrendale, PA (US)

(72) Inventors: William Carl LENTHE, Glenshaw, PA (US); Stuart Ian WRIGHT, St. George, UT (US); Matthew McBride NOWELL, Riverton, UT (US)

(21) Appl. No.: 19/067,305

(22) Filed: Feb. 28, 2025

Related U.S. Application Data
(60) Provisional application No. 63/560,517, filed on Mar. 1, 2024.

(51) Int. Cl. G01N 23/2055; G01N 23/20058; G01N 23/203

(52) U.S. Cl. CPC G01N 23/2055; G01N 23/20058; G01N 23/203

(57) ABSTRACT

A system may obtain a first experimental diffraction pattern. A system may identify a crystallographic orientation of the first experimental diffraction pattern. A system may create an experimental master pattern including at least a portion of the first experimental diffraction pattern. A system may generate a plurality of experimental indexing patterns based at least partially on the experimental master pattern. A system may forward model indexing a second experimental diffraction pattern with at least one experimental indexing pattern of the plurality of experimental indexing patterns.

### CROSS-REFERENCE TO RELATED APPLICATIONS

The present application claims priority to and the benefit of U.S. Provisional Patent Application No. 63/560,517 filed Mar. 1, 2024 entitled “DEVICES AND SYSTEMS FOR EXPERIMENTAL FORWARD MODEL INDEXING OF ELECTRON BACKSCATTER DIFFRACTION PATTERNS”, the disclosure of which is incorporated herein by reference in its entirety.

### BACKGROUND OF THE DISCLOSURE

Electron Backscatter Diffraction (“EBSD”) and transmission Kikuchi diffraction (“TKD”) have grown into a robust analytic technique for the measurement of material properties. EBSD is an analytical technique performed in a scanning electron microscope (“SEM”) in a low pressure or near vacuum environment. TKD is an analytical technique performed in a transmission microscope environment in a low pressure or near vacuum environment. A sample is positioned beneath a column housing an electron source. The electron source may be any suitable source, such as a tungsten filament, thermal field emission, or LaB6 electron source. The electron source may emit electrons that are directed in a beam through the column and toward a sample chamber. The sample chamber may be connected to the column and allow a sample to be held in line with the electron beam for imaging. The sample may have a prepared surface that is substantially flat and free of deformation from the preparation (i.e. polishing).

As shown in FIG. 1, conventional EBSD may be conducted in an SEM 100 by presenting a sample 102 at an angle 104 to an electron beam 106. The angle 104 may be any angle within a range of values from 1° to 50° degrees and most commonly, 20° to the beam. The position of the sample 102 relative to the beam 106 may be achieved by tilted a sample stage 108 approximately 70° from level or by providing a sample holder (not shown) having non-parallel surfaces mounted to the sample stage 108 or a combination of the two. The angle 104 of the sample 102 relative to the beam 106 allows electrons from the beam 106 to enter a portion of the sample 102. In the portion of the sample, known as the interaction volume, electrons diffract from crystal planes inside the sample 102. The electrons travel from the interaction volume toward a detector 110 in a geometric pattern of relative intensities of diffracted electrons 112. The diffracted electrons 112 may be measured to calculate the relationship of crystal planes within the interaction volume and, therefore, an orientation of the crystal planes in space relative to the sample surface or other prescribed reference frame.

Lenses 114, such as electromagnetic lenses, may focus and/or deflect the electron beam 106 at different working distances (focal length beneath a lowest point of the column 116) and/or locations on the sample 102. A “scan” of the SEM 100 may include construction of an image of a surface of the sample 102 by rastering the beam 106 through a predetermined range of positions and/or deflections of the beam 106. A combination of the EBSD detector 110 and rastering of the beam 106 allow for the construction of orientation maps of a portion of the sample 102. An orientation map may allow for the measurement of grain size and shape, plastic deformation, orientation distribution, texture measurements, phase relationships, transformations, grain boundary relationships, and other properties. Additionally, the orientation map may allow visualization of the spatial relationship of the measurements. While at least partially dependent on the SEM and settings (e.g., accelerating voltage, beam current, pressure in the chamber, etc.) used, ESBD in an SEM may allow for grain resolution down to 20 nm or less on bulk samples.

Collection rates for individual diffraction patterns may range from 2 seconds per pattern to well over 6000 patterns per second. The collection rate of the EBSD detector 110 may depend at least partially upon the settings of the SEM 100 and the settings and/or specifications of the EBSD detector 110. The collection rate of the EBSD detector 110 may also depend at least partially upon the sample from which orientations are measured. The diffraction volume may produce less than ideal diffraction patterns due to a number of factors, including poor surface preparation, fine grain size, deformation, hydrocarbon contamination, oxide surface layers, or combinations thereof. For example, a longer dwell time may be necessary to achieve satisfactory contrast in the collected diffraction pattern or a sufficient signal to noise ratio to measure and calculate an orientation of the sample 102 where the beam 106 meets the sample 102. In many laboratories, instrument time is a priority, therefore increasing collection speed and increasing high confidence orientation measurement rates on a variety of sample types may be desirable.

### SUMMARY

In some aspects, the techniques described herein relate to a method for characterizing a material, the method including: obtaining a first experimental diffraction pattern; identifying a crystallographic orientation of the first experimental diffraction pattern; creating an experimental master pattern including at least a portion of the first experimental diffraction pattern; generating a plurality of experimental indexing patterns based at least partially on the experimental master pattern; and forward model indexing a second experimental diffraction pattern with at least one experimental indexing pattern of the plurality of experimental indexing patterns.

In some aspects, the techniques described herein relate to a method for characterizing a material, the method including: obtaining a first experimental diffraction pattern; determining at least one point of symmetry based at least partially on the first experimental diffraction pattern; determining a crystallographic orientation of the experimental diffraction pattern based on a location and type of the at least one point of symmetry; creating an experimental master pattern including at least a portion of the first experimental diffraction pattern based at least partially on a determined crystallographic orientation; generating a plurality of experimental indexing patterns based at least partially on the experimental master pattern; and forward model indexing a second experimental diffraction pattern with at least one experimental indexing pattern of the plurality of experimental indexing patterns.

This summary is provided to introduce a selection of concepts that are further described below in the detailed description. This summary is not intended to identify specific features of the claimed subject matter, nor is it intended to be used as an aid in limiting the scope of the claimed subject matter.

Additional features of embodiments of the disclosure will be set forth in the description which follows. The features of such embodiments may be realized by means of the instruments and combinations particularly pointed out in the appended claims. These and other features will become more fully apparent from the following description and appended claims or may be learned by the practice of such exemplary embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 depicts an embodiment of conventional electron backscatter diffraction (“EBSD”) pattern collection in a scanning electron microscope (“SEM”);

FIG. 2-1 is an embodiment of a dynamically-calculated Kikuchi-sphere (K-sphere).

FIG. 2-2 illustrates a gnomonic projection of the K-sphere of FIG. 2-1 onto a flat surface as would be collected by the EBSD detector.

FIG. 3 is a comparison of K-spheres viewed at the same orientation of the crystal structure generating the electron diffraction.

FIG. 4 shows a first sampling location and a plurality of adjacent sampling locations within a grain of the sample.

FIG. 5-1 and FIG. 5-2 illustrate an experimentally collected portion of the K-sphere providing a portion of an experimental K-sphere.

FIG. 6 illustrates a comparison of experimental K-spheres, kinematically calculated K-spheres, and dynamically calculated K-spheres.

FIG. 7 is a series of experimental orientation maps collected from a nickel alloy sample at 20 keV in an electron microscope using different indexing methodologies.

FIG. 8-1 is a flowchart illustrating an embodiment of a method of characterizing a material.

FIG. 8-2 is a comparison of an embodiment of experimental patterns to the experimental indexing patterns and dynamical indexing patterns.

FIG. 8-3 is a flowchart illustrating a variation of the method of FIG. 8-1.

FIG. 9-1 is a flowchart illustrating another embodiment of a method of characterizing a material.

FIGS. 9-2 and 9-3 are illustrations of the method of FIG. 9-1.

FIG. 10 is a schematic illustration of an embodiment of a computing system.

### DETAILED DESCRIPTION

One or more specific embodiments of the present disclosure will be described below. In an effort to provide a concise description of these embodiments, some features of an actual embodiment may be described in the specification. It should be appreciated that in the development of any such actual embodiment, as in any engineering or design project, numerous embodiment-specific decisions will be made to achieve the developers' specific goals, such as compliance with system-related and business-related constraints, which may vary from one embodiment to another. It should further be appreciated that such a development effort might be complex and time consuming, but would nevertheless be a routine undertaking of design, fabrication, and manufacture for those of ordinary skill having the benefit of this disclosure.

An electron backscatter diffraction (“EBSD”) detector may collect a diffraction pattern using an image generation surface and an image collection device. For example, an image collection device, such as a Complementary Metal-Oxide-Semiconductor (CMOS) sensor, may be positioned near an end of the EBSD detector proximate a crystalline sample in a scanning electron microscope (“SEM”). The image collection device may be situated behind (i.e., farther from the sample) an image generation surface. The image generation surface may generate a signal and/or image visible to the image collection device based on the presence of electrons at or near the image generation surface. For example, a scintillator may receive incident electrons and re-emit light. The light may be collectable by the image collection device. In another example, direct electron detection may be used to generate and/or collect a diffraction pattern image without the generation of light by the image generation surface. Electrons from an electron beam may be diffracted toward the image generation surface by a plurality of crystal planes in the prepared sample. The repeating crystal planes of the sample may diffract the electrons in an array of geometrically related “bands” of electrons. The electron bands may strike the image generation surface and may be collected by the image collection device.

The electron beam may interact with the crystal lattice of the sample at the surface and in a subsurface interaction volume. A crystal orientation of the crystal lattice may be calculated from the resulting diffracted electrons. A diffraction pattern comprising a plurality of electron bands may be measured and an orientation calculated based on known crystal structure parameters for the sampled crystal lattice and the relative location of detected electron bands in the pattern. In some samples, the quality of the diffraction may be less than desired. For example, the signal-to-noise ratio of the electron bands, the contrast in the image, or other image quality degradation may compromise accurate detection of electron bands within the diffraction pattern.

Dictionary indexing may allow for the indexing of lower-quality collected diffraction patterns. For example, Hough indexing is an inverse model solution that transforms the electron bands of the collected diffraction pattern to a point within a 2-dimensional coordinate space with intensity values (visualized as greyscale values) in the transform to locate the relative position of the diffraction bands. However, the reliability of the Hough transform from the collected pattern are limited by the quality of the diffraction pattern, which can degrade during data collection from a sample due to detector settings, microscope settings, sample conditions, vacuum condition in the microscope, or other considerations.

Dictionary indexing is a forward model indexing methodology that relies upon a pre-determined master pattern of a Kikuchi sphere (K-sphere) to generate an array (dictionary) of patterns at various crystal orientations. With a dictionary of patterns generated at known orientations, the system can compare a collected diffraction pattern to the dictionary to determine a closest match. The accuracy and/or precision of the closest match is based at least partially on the angular displacement between each known orientation. For example, a dictionary of patterns at known orientations with 1° between each orientation may provide more accurate and/or more precise matches than a dictionary with 3° between each known orientation. Other forward model indexing techniques include spherical harmonic transform (SHT) indexing and refinement of a prior indexing result.

In some embodiments, the system collects a diffraction pattern from a sample and indexes the collected diffraction pattern. As used herein, “indexing” should be understood to refer to the calculation of one or more crystal orientations at which the sampled portion of the crystal lattice may be oriented relative to a surface of the sample. In some embodiments, the orientation of the crystal lattice may be calculated relative to another reference frame. For example, a user may desire the orientation to be calculated relative to a transverse axis of the sample surface, such as when evaluating texture or preferred crystallographic orientations in extruded materials in longitudinal cross-section.

Indexing a diffraction pattern may include detecting at least three electron bands in a diffraction pattern, such as the averaged diffraction pattern, selecting a plurality of sets of three electron bands (“a triplet”) from the at least three electron bands, and calculating a one or more crystallographic orientations for each triplet based on known lattice parameters. For example, a diffraction pattern having five detected electron bands may have ten triplets. A single triplet may provide a plurality of crystallographic orientations. Indexing a diffraction pattern may include determining the orientation calculated most frequently based on the plurality of triplets.

A confidence index may be calculated during indexing. The confidence index may be a weighted ratio of the most likely orientation and a second-most likely orientation. A crystal lattice may exhibit various forms of symmetry. The symmetry of the crystal lattice may manifest as symmetry in the diffraction pattern. Symmetry in the diffraction pattern may lead a single triplet to provide multiple possible orientations of a crystal lattice that may correspond to the measured triplet. Therefore, a single triplet alone may lead to ambiguity and/or “false positives.” However, taken in aggregate, multiple triplets may align with a one orientation more often than a second orientation. A confidence index may reflect the rate at which a “correct” orientation is calculated to match the detected triplets versus a “false positive.” A confidence index may be calculated by

CI=(V₁−V₂)/V_{Ideal} (1)

where CI is the confidence index; V₁ and V₂ are the number of triplets that may correspond to the most likely orientation and the second-most likely orientation, respectively; and V_{Ideal} is the total possible number of triplets that may correspond to an orientation (i.e., the total number of detected triplets). The confidence index may allow a user to determine the level of ambiguity in a system exhibiting symmetry.

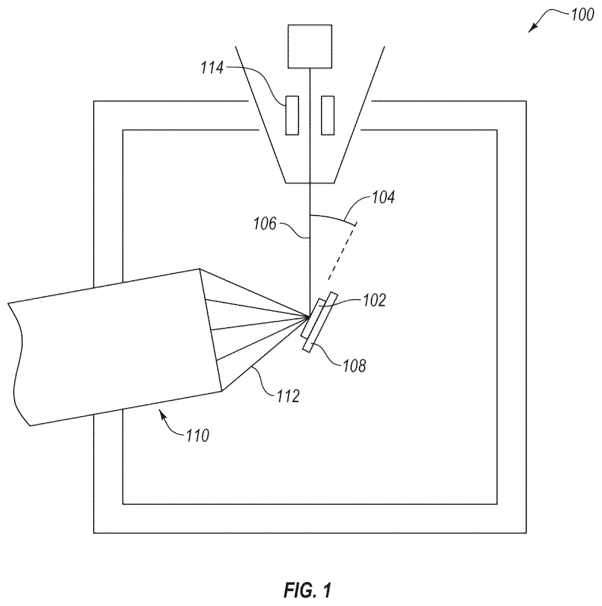

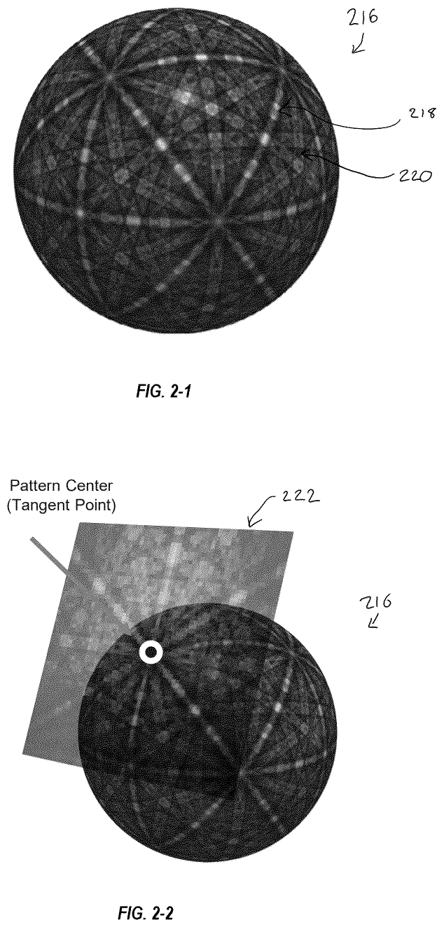

FIG. 2-1 depicts an embodiment of a K-sphere 216 according to the present description. The K-sphere 216 may exhibit areas of high electron concentration and areas of lower electron concentration. The high electron concentration may manifest as a brighter electron band 218 and the lower electron concentration may manifest as darker region 220 between the electron bands 218. As described herein, “brighter” and “darker” should be understood to refer to the relative appearance of the electron concentrations after interaction with an image generation surface, such as a phosphor scintillator. The brighter and darker regions correspond to the intensity of the electron concentration due to the constructive and deconstructive interference of the electrons diffracting from the crystal lattice of the sample.

The electron bands 218 may exhibit a higher concentration of electrons due to the diffraction of electrons from the repeating crystal planes of a crystal lattice. The repeating crystal planes may diffract incident electrons from an electron beam toward an EBSD detector. The diffraction may create regions of higher and lower electron intensity due, at least partially, to constructive and deconstructive interference of the electrons having different paths lengths relative to the lattice parameters. The darker regions 220 may exhibit some electron interactions due to electrons scattered toward the EBSD detector without exhibiting diffraction.

The K-sphere 216 illustrated in FIG. 2-1 is a dynamically calculated K-sphere 216 of face-centered cubic nickel at a 20 kilo-electron-volt (keV) accelerating voltage of an electron beam. FIG. 2-2 illustrates a gnomonic projection of the K-sphere 216 onto a flat surface as would be collected by the EBSD detector. During data collection from a sample, the collected diffraction pattern 222 may exhibit variations in intensity across the pattern for reasons unrelated to diffraction of the electrons from the crystal lattice. For example, diffraction patterns may exhibit intensity variations due to deformation of the crystal lattice. In an ideal example, the crystal lattice may be undeformed and may have repeating crystal planes which are parallel and evenly spaced, providing ideal diffraction surfaces from which the incident electrons may diffract. In a deformed sample, one or more bonds in the crystal lattice may be strained such that one or more crystal planes are misaligned. As used herein, “misaligned” should be understood refer to a crystal plane in a plurality of crystal planes that is not parallel to the other crystal planes. The one or more misaligned planes may limit the constructive and deconstructive interference of the diffracted electrons and may decrease contrast in a diffraction pattern. The quality of the collected diffraction pattern can be further affected by other sample or system conditions, such as surface roughness, shadowing, beam conditions, etc. Decreased contrast in a diffraction pattern may reduce the signal to noise ratio of the pattern and limit the number of detectable electron bands 218 and/or the accurate detection of the electron bands 218.

In some embodiments, the experimentally collected diffraction pattern may vary from the dynamically calculated K-sphere and projected diffraction patterns derived therefrom based on a variety of settings, conditions, and system properties. For example, the experimentally collected diffraction pattern may vary from the dynamically calculated K-sphere and projected diffraction patterns derived therefrom based at least partially on electron beam current, accelerating voltage, collimation, focus, vacuum condition in the chamber, dwell time at a sampling location, or other operating conditions of the electron microscope (or other excitation source). In some examples, the experimentally collected diffraction pattern may vary from the dynamically calculated K-sphere and projected diffraction patterns derived therefrom based at least partially on sample condition, such as strain in the crystal lattice within the sampling volume, surface preparation, charging, proximity of the sampling location to a grain boundary, or other sample properties. In some examples, the experimentally collected diffraction pattern may vary from the dynamically calculated K-sphere and projected diffraction patterns derived therefrom based at least partially on the EBSD detector settings, such as resolution, exposure, gain, and other settings. In some examples, the experimentally collected diffraction pattern may reflect an unknown structure.

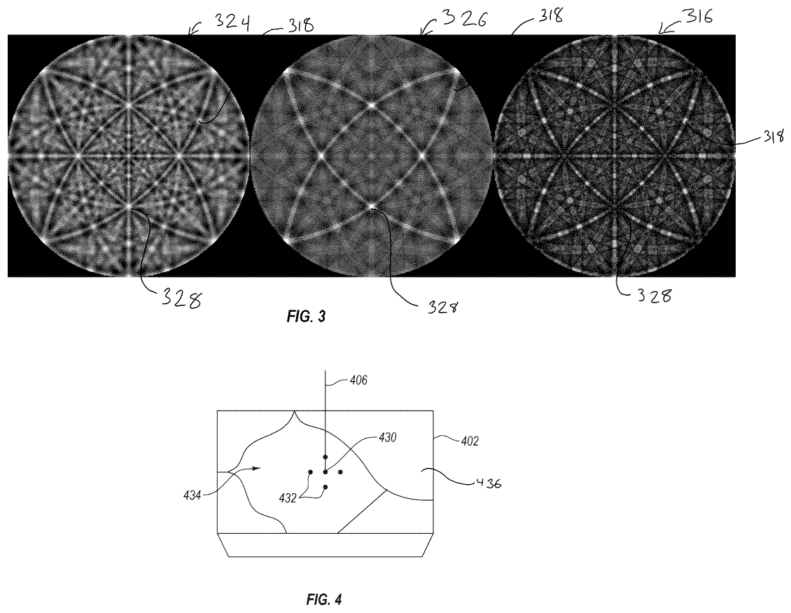

FIG. 3 is a comparison of K-spheres viewed at the same orientation of the crystal structure generating the electron diffraction. Each K-sphere represents electron diffraction patterns from face-centered cubic (FCC) nickel at 20 keV. Despite the same crystal structure, the same orientation, and the same accelerating voltage, the experimental K-sphere 324, the kinematically calculated K-sphere 326, and the dynamically calculated K-sphere 316 exhibit different features. In particular, the diffraction bands 318 and the zone axes 328 at which the diffraction bands 318 intersect exhibit different levels of contrast and different levels of definition. For example, the zone axes 328 on the experimental K-sphere 324 appear larger than those of the dynamically calculated K-sphere 316. Conventional dictionary indexing and master patterns are calculated using a dynamical diffraction simulation (“dynamical calculation”), resulting in a master pattern and dictionary indexing patterns that are not representative of the experimental diffraction patterns collected from the microscope and EBSD detector.

An experimental K-sphere is assembled from collected diffraction patterns from the EBSD system that are reflective of the sample condition, the beam condition, and the EBSD detector that are to be used for the collection of the EBSD data and associated maps. The experimental K-sphere can, therefore, be a more accurate master pattern for dictionary indexing of the sample and EBSD system used to collect data from the sample. In some embodiments, indexing collected diffraction patterns in a repeating grid or distribution of sampling locations provides a map of the sample microstructure and statistics of the microstructure.

For example, FIG. 4 illustrates a sample 402 and an incident electron beam 406 focused on a first sampling location 430, according to at least one embodiment described herein. The first sampling location 430 may be approximated as a point on a surface of the sample 402 but may vary in size depending on the settings and configuration of the electron beam 406. For example, the source of the electron beam 406 may be a thermal field emission source, a tungsten-filament source, or another electron source. A thermal field emission source may produce an electron beam having a diameter less than 5 nanometers when properly calibrated, focused, and stigmated. A tungsten-filament source may produce an electron beam having a diameter greater than about 30 nanometers when properly calibrated, focused, and stigmated. The first sampling location 430 may also include interactions between the electron beam 406 and the sample 402 that occur below the surface of the sample 402. For example, the first sampling location 430 may include an interaction volume. The interaction volume may be determined, at least partially by the accelerating voltage and current of the electron beam 406 and the sample 402 (e.g., material type and/or sample preparation).

A first sampling location 430 may be proximate to one or more adjacent sampling locations 432, shown in FIG. 4 as being positioned according to a rectangular grid. In other embodiments, the one or more adjacent sampling locations 432 may be defined according to a hexagonal grid, a pentagonal grid, octagonal grid, or other repeating or automated sampling system. For example, the sampling locations 430, 432 may be selected at random on the surface of the sample with regular or irregular spacing therebetween. A distance between a center point of the first sampling location 430 and the one or more adjacent sampling locations 432 may be understood to be a “step size” between the sampling locations. In some embodiments, the one or more additional sampling locations 432 may be immediately adjacent the first sampling location 430 based upon a step size that is approximately equal a nominal diameter of the electron beam 406. In other embodiments, the one or more adjacent sampling locations 432 may be immediately adjacent the first sampling location 430 based upon a step size that is approximately equal a simulated interaction volume of the electron beam 406 within the sample 402 (e.g., a Monte Carlo simulation). In yet other embodiments, the one or more adjacent sampling locations 432 may be adjacent the first sampling location 430 based upon a step size for an automated sampling grid that is selected by a user based on one or more dimensions of the sample 402, a desired diffraction pattern set size, collection duration, other factors, or combinations thereof. The first sampling location and adjacent sampling locations should not be understood to imply a collection sequence or order, but merely mean to differentiate the sampling locations for descriptive purposes.

FIG. 4 shows a first sampling location 430 and a plurality of adjacent sampling locations 432 within a grain 434 of the sample 402. As used herein, a grain 434 should be understood to include any crystalline structure with a substantially continuous crystal lattice. For example, a grain 434 may be deformed and may exhibit strain within the crystal lattice leading to misaligned planes and/or dislocations within the crystal lattice while still having a continuous crystal lattice. Within a grain or across grains in the sample, the diffraction patterns generated and collected by the system may reflect different orientations of the crystal lattice. Each experimental diffraction pattern, therefore, represents a portion of the experimental K-sphere.

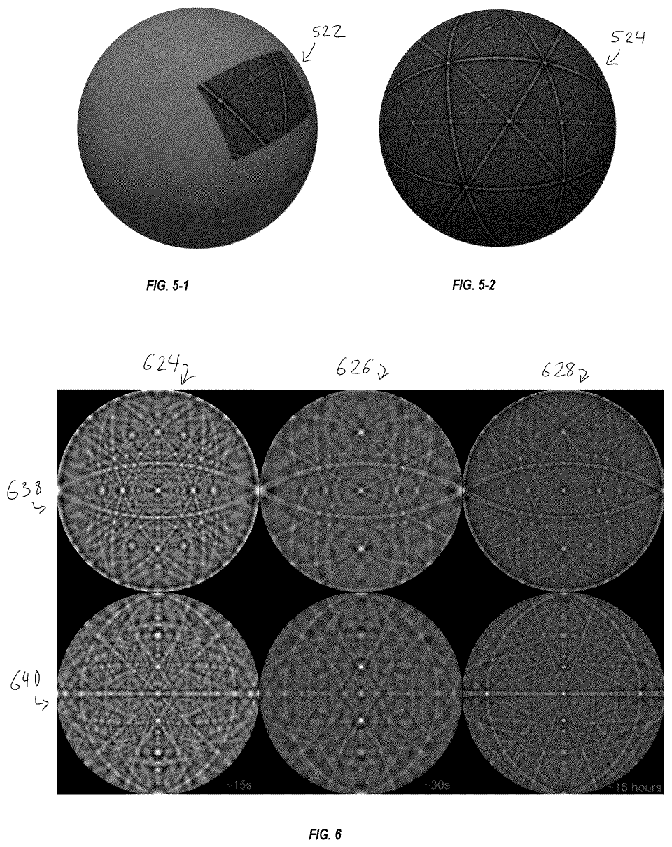

FIG. 5-1 and FIG. 5-2 illustrate how an experimentally collected pattern provides a portion of the experimental K-sphere. For example, systems and methods according to the present disclosure, in some embodiments, include collecting a plurality of experimental diffraction patterns and aligning at least a portion of a first experimental diffraction pattern of the plurality of experimental diffraction patterns with a portion of a second experimental diffraction pattern of the plurality of experimental diffraction patterns to assemble the experimental K-sphere. For example, edge detection, contract detection, Fourier transforms, or other image processing techniques may allow the alignment and matching of overlapping and/or adjacent portions of experimental diffraction patterns to assemble the experimental K-sphere.

In some embodiments, systems and methods according to the present disclosure include collecting a plurality of experimental diffraction patterns and indexing the at least some of the experimental diffraction patterns to determine a location of the experimental diffraction pattern on the experimental K-sphere. In some embodiments, the location is based upon a crystallographic orientation measured at the sampling location. In some embodiments, indexing the experimental diffraction pattern includes using a Hough transform or other inverse model indexing technique. In some embodiments, indexing the experimental diffraction pattern includes using dynamically calculated dictionary indexing, SHT indexing, or other forward model indexing technique.

FIG. 6 illustrates a comparison of experimental K-spheres 624, kinematically calculated K-spheres 626, and dynamically calculated K-spheres 616 for forsterite 638 and enstatite 640. The experimental K-spheres 624 were calculated and assembled from experimental diffraction patterns in approximately 15 seconds. The kinematically calculated K-spheres 626 were calculated and assembled from experimental diffraction patterns in approximately 30 seconds. The dynamically calculated K-spheres 616 were calculated and assembled from experimental diffraction patterns in approximately 16 hours. The experimental K-spheres 624, therefore, provide significant computational resource savings over the conventional dynamically calculated K-spheres 616. Additionally, the orientation mapping and indexing quality may be improved by forward model indexing using the experimental K-spheres 624 and/or an experimental master pattern, as will be described in more detail herein.

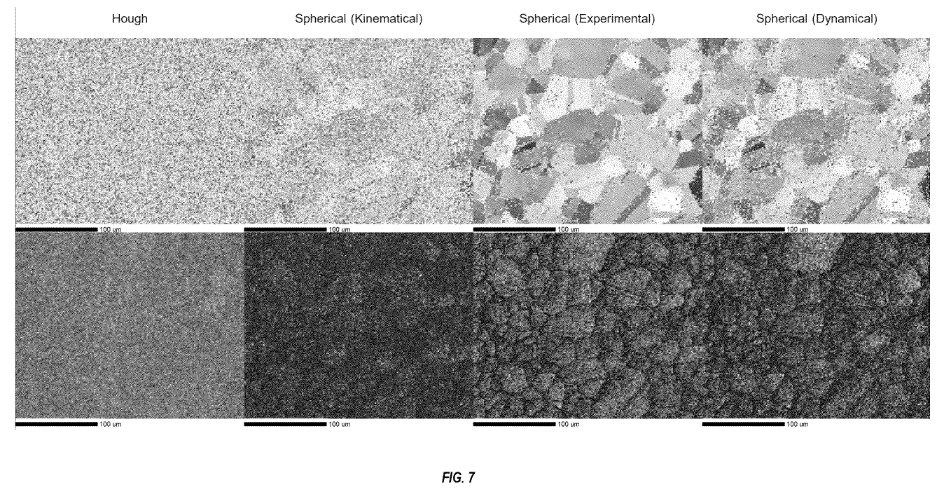

FIG. 7 is a series of experimental orientation maps collected from a nickel alloy sample at 20 keV in an electron microscope using different indexing methodologies. The color of the pixel correspond to the calculated orientation of the crystal structure of the sample at the sampling location associated with the pixel. The relatively random color distribution of the Hough-calculated orientation map reflects the relative inability of the Hough transform indexing to consistently or accurately identify the crystal orientation of based on collected diffraction patterns during a live scan.

The second, third, and fourth experimental orientation maps illustrate the orientation mapping based on forward model indexing using a kinematically-calculated K-sphere and master pattern, an experimental K-sphere and master pattern, and a dynamically-calculated K-sphere and master pattern, respectively. The greyscale maps below the dictionary indexing orientation maps each reflect measure of confidence in the indexing solution of each pixel. The lighter greyscale values are associated with higher CI values and represent better quality indexing. The experimental orientation mapping, therefore, reflects the highest quality indexing of the three methodologies while also requiring the lowest computational resources, as described in relation to FIG. 6.

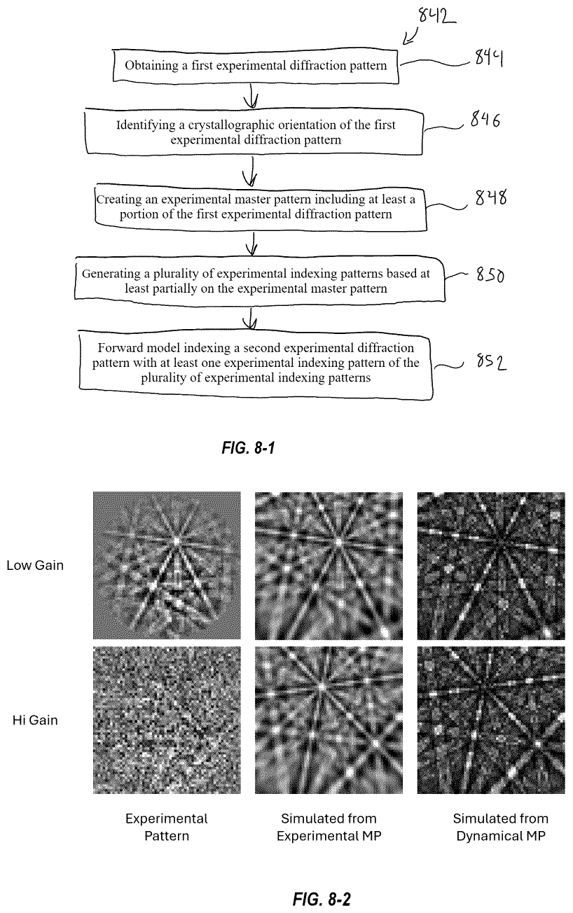

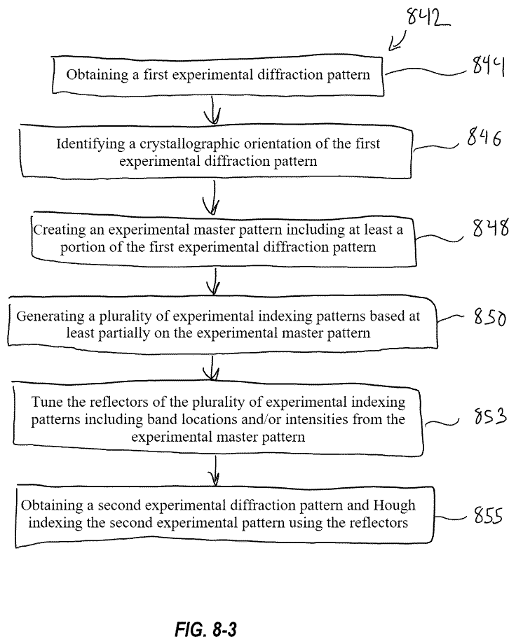

FIG. 8-1 is a flowchart illustrating an embodiment of a method 842 of characterizing a material. In some embodiments, the method includes obtaining a first experimental diffraction pattern at 844. In some embodiments, obtaining the first experimental diffraction pattern includes collecting the first experimental diffraction pattern live on the microscope and EBSD detector. In some embodiments, obtaining the first experimental diffraction pattern includes accessing a stored first experimental diffraction pattern from a prior data collection session. The stored first experimental diffraction pattern may be obtained from a local storage device, such as volatile or non-volatile storage media local to the computing device performing at least one other portion of the method 842. In some embodiments, the stored first experimental diffraction pattern is obtained from a remote storage device or media, such as via a network.

In some embodiments, the method 842 further includes identifying a crystallographic orientation of the experimental diffraction pattern at 846 and creating an experimental master pattern including at least a portion of the first experimental diffraction pattern at 848. In some embodiments, identifying the crystallographic orientation includes inverse model indexing. For example, identifying the crystallographic orientation may include Hough indexing. In some embodiments, identifying the crystallographic orientation includes forward model indexing. For example, identifying the crystallographic orientation may include dictionary indexing.

In some embodiments, creating an experimental master pattern includes aligning at least a portion of the first experimental diffraction pattern with another portion of another experimental diffraction pattern. In some embodiments, creating an experimental master pattern includes overlapping at least a portion of the first experimental diffraction pattern with another portion of another experimental diffraction pattern.

In some embodiments, the method 842 further includes generating a plurality of experimental indexing patterns based at least partially on the experimental master pattern at 850. Generating a plurality of experimental indexing patterns includes iterating through a series of angular displacements of the master pattern and recording and/or storing the plurality of experimental indexing patterns projected therefrom. The plurality of experimental indexing patterns are then used for forward model indexing of a second experimental diffraction pattern at 852. In some embodiments, by creating an experimental master pattern and experimental indexing patterns from the experimental master pattern, a computing system and/or data collection system reduces computational resources and improves orientation mapping quality.

FIG. 8-2 is a comparison of experimental diffraction patterns collected from a sample against dictionary indexing patterns simulated from an experimental master pattern (i.e., experimental indexing patterns) and dictionary indexing patterns simulated from a dynamical master pattern (i.e., dynamical indexing patterns). FIG. 8-2 includes experimental diffraction patterns collected from a sample using a detector with a low gain setting (the upper-left image) and with a high gain setting (the lower-left image). High gain is often used to reduce exposure time of the detector (or other camera) enabling a higher frame rate and more patterns per second. The center column of FIG. 8-2 are the experimental indexing patterns created by projecting the experimental master pattern onto a flat surface (e.g., as described in relation to FIG. 2-1 and FIG. 2-2). The experimental diffraction patterns exhibit greater similarly to the experimental indexing patterns in electron band and zone axis characteristics than the dynamical indexing patterns (the right column). As noted in relation to FIG. 7, the experimental indexing patterns generated from the experimental master patterns provide the best quality indexing, even at high frame rates with high gain settings.

FIG. 8-3 is a flowchart illustrating a variation of the embodiment of the method 842 for characterizing a material described in relation to FIG. 8-1. In some other embodiments, the method 842 begins similarly to that of FIG. 8-1, but leverages different reflectors Hough indexing. In a conventional indexing using a Hough transform, the indexing uses a list of reflectors (bands) and their expected intensity (weights) for a given structure. Conventionally, the bands and respective intensities have been obtained through manual tuning of individual bands from experimental patterns, or the bands and respective intensities are obtained from kinematical structure factors. In some embodiments according to the present disclosure, the bands and intensities are obtained and/or tuned based on one or more experimental master patterns.

For example, the variation on the method 842 as illustrated in the embodiment of FIG. 8-3 includes obtaining a first experimental diffraction pattern at 844. In some embodiments, obtaining the first experimental diffraction pattern includes collecting the first experimental diffraction pattern live on the microscope and EBSD detector. In some embodiments, obtaining the first experimental diffraction pattern includes accessing a stored first experimental diffraction pattern from a prior data collection session. The stored first experimental diffraction pattern may be obtained from a local storage device, such as volatile or non-volatile storage media local to the computing device performing at least one other portion of the method 842. In some embodiments, the stored first experimental diffraction pattern is obtained from a remote storage device or media, such as via a network.

In some embodiments, the method 842 further includes identifying a crystallographic orientation of the experimental diffraction pattern at 846 and creating an experimental master pattern including at least a portion of the first experimental diffraction pattern at 848. In some embodiments, identifying the crystallographic orientation includes inverse model indexing. For example, identifying the crystallographic orientation may include Hough indexing. In some embodiments, identifying the crystallographic orientation includes forward model indexing. For example, identifying the crystallographic orientation may include dictionary indexing.

In some embodiments, creating an experimental master pattern includes aligning at least a portion of the first experimental diffraction pattern with another portion of another experimental diffraction pattern. In some embodiments, creating an experimental master pattern includes overlapping at least a portion of the first experimental diffraction pattern with another portion of another experimental diffraction pattern.

In some embodiments, the method 842 further includes generating a plurality of experimental indexing patterns based at least partially on the experimental master pattern at 850. Generating a plurality of experimental indexing patterns includes iterating through a series of angular displacements of the master pattern and recording and/or storing the plurality of experimental indexing patterns projected therefrom.

In some embodiments, the method 842 includes tuning one or more reflectors based on one or more experimental master patterns at 853. In some embodiments, tuning the one or more reflectors includes changing at least one band location based on the experimental master pattern. In some embodiments, tuning the one or more reflectors includes changing at least one band orientation based on the experimental master pattern. In some examples, the band orientation and location may be the same property such as when considered on a spherical system, such as a K-sphere. In some examples in which the pattern is projected onto a plane, the band orientation and band location may be independent of one another. In some embodiments, tuning the one or more reflectors includes changing at least one band width based on the experimental master pattern. In some embodiments, tuning the one or more reflectors includes changing at least one band intensity based on the experimental master pattern. In some embodiments, changing at least one band intensity includes setting the intensity to zero to effectively ignore that band in the pattern.

After tuning the reflectors, the method 842 includes obtaining a second experimental diffraction pattern and Hough indexing the second experimental diffraction pattern using reflectors tuned on experimental master pattern at 855.

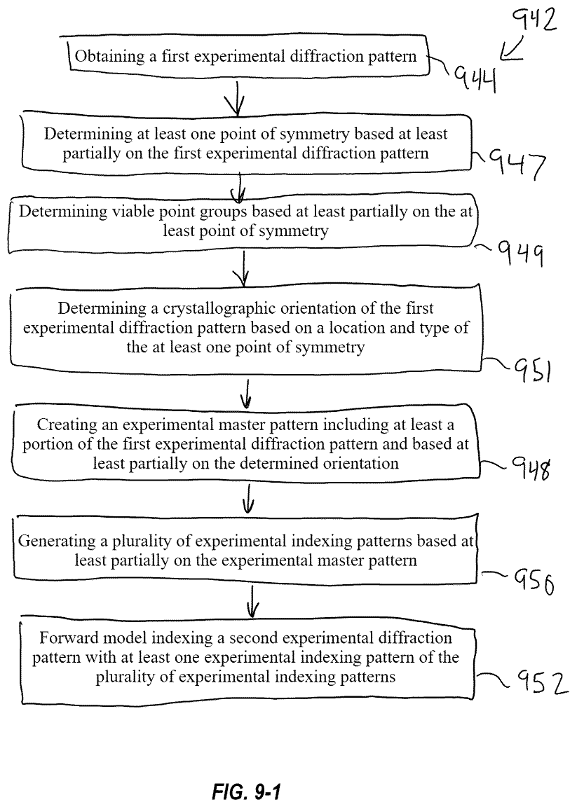

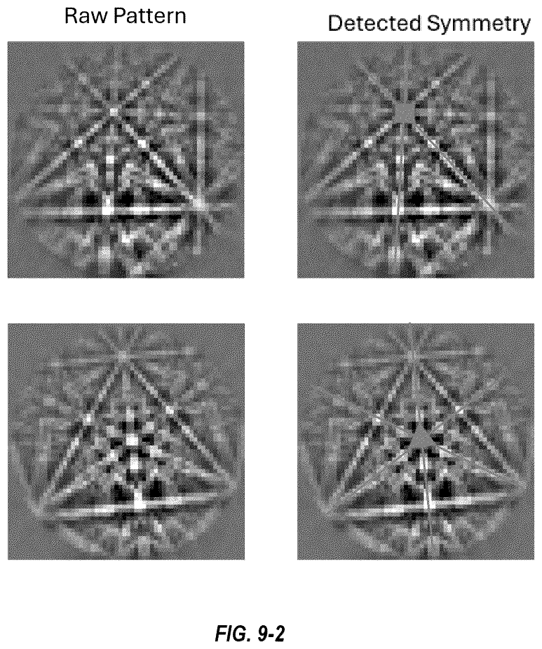

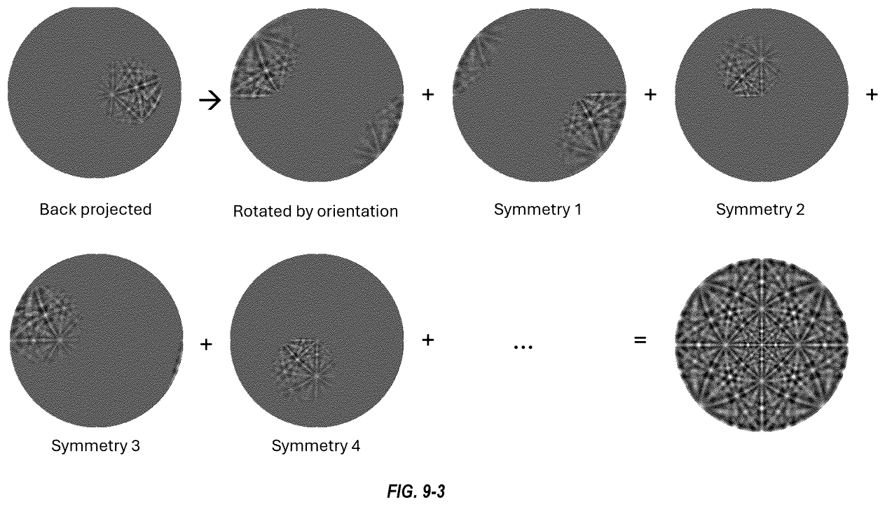

FIG. 9-1 is a flowchart illustrating another embodiment of a method 942 of characterizing a material. In some embodiments, the method includes obtaining a first experimental diffraction pattern at 944. In some embodiments, obtaining the first experimental diffraction pattern includes collecting the first experimental diffraction pattern live on the microscope and EBSD detector. In some embodiments, obtaining the first experimental diffraction pattern includes accessing a stored first experimental diffraction pattern from a prior data collection session. The stored first experimental diffraction pattern may be obtained from a local storage device, such as volatile or non-volatile storage media local to the computing device performing at least one other portion of the method 942. In some embodiments, the stored first experimental diffraction pattern is obtained from a remote storage device or media, such as via a network.

In some embodiments, the method 942 further includes determining at least one point of symmetry based at least partially on the first experimental diffraction pattern at 947. The point of symmetry may be or include mirror symmetry, inversion symmetry, rotational symmetry, or other points of symmetry. For example, based at least partially on the point of symmetry, the same or similar distribution of diffraction bands, zone axes, or other aspects of the collected signal present in the first experimental diffraction pattern will be present on a K-sphere of the sample crystal structure. For example, inversion symmetry may indicate that the same or similar distribution of diffraction bands and zone axis present in the first experimental diffraction pattern will be present on an opposite portion of the K-sphere of the sample crystal structure from the crystallographic orientation of the first experimental diffraction pattern calculated prior.

In some embodiments, the method 942 includes determining viable point groups based at least partially on the at least one point of symmetry at 949. Based at least partially on the location and type of the at least one point of symmetry, the method 942 includes determining a crystallographic orientation of the first experimental diffraction pattern based on the location and the type of the at least one point of symmetry at 951.

In some embodiments, identifying the crystallographic orientation includes inverse model indexing. For example, identifying the crystallographic orientation may include Hough indexing. In some embodiments, identifying the crystallographic orientation includes forward model indexing. For example, identifying the crystallographic orientation may include dictionary indexing. In some embodiments, identifying the crystallographic orientation includes determining the crystallographic orientation from the point(s) of symmetry in the experimental diffraction pattern as will be described in relation to FIG. 9-2.

In some embodiments, method 942 further includes creating an experimental master pattern including at least a portion of the first experimental diffraction pattern at 948. In some embodiments, creating an experimental master pattern includes aligning at least a portion of the first experimental diffraction pattern with another portion of another experimental diffraction pattern. In some embodiments, creating an experimental master pattern includes overlapping at least a portion of the first experimental diffraction pattern with another portion of another experimental diffraction pattern.

In some embodiments, the method 942 further includes generating a plurality of experimental indexing patterns based at least partially on the experimental master pattern at 950. Generating a plurality of experimental indexing patterns includes iterating through a series of angular displacements of the master pattern and recording and/or storing the plurality of experimental indexing patterns. The plurality of experimental indexing patterns is then used for forward model indexing of a second experimental diffraction pattern at 952. In some embodiments, by creating an experimental master pattern and experimental indexing patterns from the experimental master pattern, a computing system and/or data collection system reduces computational resources and improves orientation mapping quality.

FIG. 9-2 illustrates an example of determining at least one point of symmetry based at least partially on the first experimental diffraction pattern at 947. The left column illustrated two examples of experimental diffraction patterns collected from a sample using an EBSD detector. The zone axes and electron bands are located, as described herein, in the right column. When the zone axes and electron bands are located, the displacement and angular relationships therebetween can be calculated through mapping the projection collected by the detector surface (e.g., the image generation surface) onto the spherical space of the K-sphere or diffraction space. In some embodiments, the various points of symmetry detected in the diffraction pattern are associated with one or more symmetry groups.

In the example of the top row of diffraction patterns, the highlighted zone axis and electron bands are associated with a 4-fold axis and mirror planes at 45°. These points of symmetry are associated with the point group of 4 mm and/or its super groups. For example, the points of symmetry of the top row of FIG. 9-2 may be associated with 4 mm (lowest symmetry option), 4/mmm, or m3 m (highest symmetry option). The orientation can then be determined (such as in 951) from the relationship of the symmetry planes:

4 fold∥+z, mirror ⊥+x

The bottom row of patterns illustrates another example in which a detected 3-fold axis and mirror planes through that zone axis is associated with the point group of 3 m or its super groups. For example, the points of symmetry of the bottom row of FIG. 9-2 may be associated with 3 m, −3 m, 6 mm, −62 m, 6/mmm, −43 m, or m3 m. The orientation is, in some embodiments, determined from the relationship of the determined crystal directions:

3 fold∥+z mirror ⊥+x

FIG. 9-3 is an embodiment of generating the experimental K-sphere and creating an experimental master pattern including at least a portion of the first experimental diffraction pattern at 948. The collected experimental diffraction pattern is mapped to the K-sphere based at least partially on the crystallographic orientation of the experimental diffraction pattern determined prior. The system then applies translations, rotation, mirrors, or combinations thereof to at least a portion of the experimental diffraction pattern based on the known point(s) of symmetry of the symmetry group. For example, FIG. 9-3 illustrates the first experimental diffraction pattern back projected onto the spherical space of the K-sphere and subsequently rotated by orientation.

The points of symmetry are applied to the first experimental diffraction pattern to map the information of the first experimental diffraction pattern to different portions of the K-sphere. For example, the zone axis and electron bands are replicated throughout the K-sphere to populate the spherical space with experimentally collected information. In some embodiments, generating the experimental K-sphere and experimental master pattern includes at least two experimental diffraction patterns. In some embodiments, generating the experimental K-sphere and experimental master pattern includes at least three experimental diffraction patterns. In some embodiments, the pixel information from the experimental diffraction patterns is averaged in overlapping regions of the experimental K-sphere and/or experimental master pattern. In some embodiments, the newly populated space in the experimental K-sphere and/or experimental master pattern is used to identify additional points of symmetry.

Embodiments described herein may be implemented on various types of computing systems. These computing systems are now increasingly taking a wide variety of forms. Computing systems may, for example, be handheld devices, appliances, laptop computers, desktop computers, mainframes, distributed computing systems, or even devices that have not conventionally been considered a computing system. As used herein, a “computing system” broadly includes any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

As used herein, the term “executable instructions” or “executable component” can refer to software objects, routings, or methods that may be executed on the computing system. The different components, modules, engines, and services described herein may be implemented as objects or processes that execute on the computing system (e.g., as separate threads).

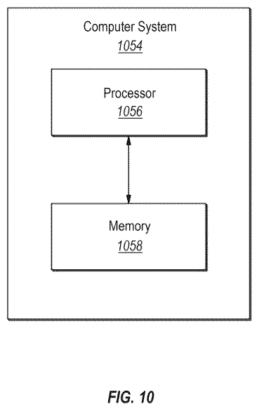

As illustrated in FIG. 10, a computing system 1054 typically includes at least one processing unit 1056 and memory 1058. The memory 1058 may be physical system memory, which may be volatile, non-volatile, or some combination of the two. The term “memory” may also be used herein to refer to non-volatile mass storage such as physical storage media or other data storage devices. If the computing system is distributed, the processing, memory, and/or storage capability may be distributed as well.

Embodiments of the methods described herein may be described with reference to acts that may be performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 1058 of the computing system 1054. Computing system 1054 may also contain communication channels that allow the computing system 1054 to communicate with other message processors over a wired or wireless network.

Embodiments described herein also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments described herein can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the functionality disclosed herein.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. Any element of an embodiment described herein may be combined with any element of any other embodiment described herein. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for characterizing a material, the method comprising:
obtaining a first experimental diffraction pattern;
identifying a crystallographic orientation of the first experimental diffraction pattern;
creating an experimental master pattern including at least a portion of the first experimental diffraction pattern;
generating a plurality of experimental indexing patterns based at least partially on the experimental master pattern; and
forward model indexing a second experimental diffraction pattern with at least one experimental indexing pattern of the plurality of experimental indexing patterns.

2. A method for characterizing a material, the method comprising:
obtaining a first experimental diffraction pattern;
determining at least one point of symmetry based at least partially on the first experimental diffraction pattern;
determining a crystallographic orientation of the experimental diffraction pattern based on a location and type of the at least one point of symmetry;
creating an experimental master pattern including at least a portion of the first experimental diffraction pattern based at least partially on a determined crystallographic orientation;
generating a plurality of experimental indexing patterns based at least partially on the experimental master pattern; and
forward model indexing a second experimental diffraction pattern with at least one experimental indexing pattern of the plurality of experimental indexing patterns.

3. The method of claim 2, further comprising determining at least a second point of symmetry based at least partially on the experimental master pattern; and
refining the experimental master pattern based at least partially on the second point of symmetry, and
wherein generating a plurality of experimental indexing patterns is based at least partially on the refined experimental master pattern.

4. A method for characterizing a material, the method comprising:
obtaining a first experimental diffraction pattern;
identifying a crystallographic orientation of the first experimental diffraction pattern;
creating an experimental master pattern including at least a portion of the first experimental diffraction pattern;
generating at least one experimental simulated pattern based at least partially on the experimental master pattern; and
displaying the experimental simulated pattern on a display device.
